(19) United States
(12) Patent Application Publication
(10) Pub. No.: US 2011/0084199 A1
(43) Pub. Date: Apr. 14, 2011

(54) OPTICAL SENSOR USING NANO-SPACER AND DETECTION METHOD USING THE SAME

(75) Inventor: Hyeon Bong PYO, Daejeon (KR)

(73) Assignee: Electronics and Telecommunications Research Institute, Daejeon (KR)

(21) Appl. No.: 12/900,030

(22) Filed: Oct. 7, 2010

(30) Foreign Application Priority Data
Oct. 9, 2009 (KR) 10-2009-0096448
Mar. 24, 2010 (KR) 10-2010-0026183

(51) Int. Cl. H01J 40/14; G01N 21/55; G01J 3/44; G01J 1/58

(52) U.S. Cl. 250/216; 356/445; 356/301; 250/458.1

(57) ABSTRACT

An optical sensor includes: a nano-spacer a length of which is reversibly varied depending on an external stimuli; a first material body coupled to one side of the nano-spacer; a second material body coupled to the other side of the nano-spacer; and a detection unit detecting light emitted by an interaction between the first material body and the second material body.

### CROSS-REFERENCE TO RELATED APPLICATIONS

This application claims the priorities of Korean Patent Application Nos. 10-2009-0096448 filed on Oct. 9, 2009 and 10-2010-0026183 filed on Mar. 24, 2010, in the Korean Intellectual Property Office, the disclosures of which are incorporated herein by reference.

### BACKGROUND OF THE INVENTION

1. Field of the Invention

The present invention relates to an optical sensor using a nano-spacer and a detection method using the same, and more particularly, to an optical sensor using a nano-spacer, which is capable of controlling and detecting optical properties through an external stimuli, and a detection method using the same.

2. Description of the Related Art

Fluorescence is the emission of light from a substance that is excited by light. Fluorescence is different from reflection in that a substance having absorbed light energy emits light having a wavelength which is longer than that of incident light, that is, light having energy which is lower than that of incident light. Also, fluorescence is distinguished from phosphorescence. In phosphorescence, emission of light from a substance retains longer even when incident radiation is removed. However, in fluorescence, emission of light from a substance decays faster than phosphorescence when incident radiation is removed.

Fluorescence resonance energy transfer (FRET) is a phenomenon which uses the energy transfer properties of a donor-acceptor pair.

When donor molecule absorbs energy from outside, the excitation energy of the donor molecule is transferred to the acceptor molecule without radiation, instead of the light emission. Thus, only the acceptor molecule emits light.

Surface plasmon refers to a surface electromagnetic wave which propagates along an interface between metal and dielectric, caused by a coherent oscillation of electrons on the surface. The surface plasmon field may be enhanced by changing the surface or structure of the metal and the related techniques can be applied to the bioanalysis or for the development of novel optical devices.

Localized surface plasmon resonance (LSPR) is a case of 0-dimensional surface plasmon resonance in which the energy of incident light is resonantly absorbed and scattered depending on the size and shape of metal nanoparticles and the dielectric properties of ambient media. This means that light energy is absorbed by the surface plasmon and converted, and an electric field induced on the surface of the metal nanoparticle is locally distorted and enhanced. Furthermore, light control can be achieved in a region smaller than the diffraction limit of light, that is, in a near field.

Raman spectroscopy is a well-known technique which provides information on the vibrational frequencies of molecules. Furthermore, surface enhanced Raman scattering (SERS) refers to a phenomenon in which the intensity of Raman signals is applied when the molecules exist on top of the corrugated metal surface.

Since the intensity of Raman signal is weaker than the fluorescence signal, there are difficulties in applying Raman spectroscopy to normal situations. However, such difficulties can be overcome by using SERS.

It is known that SERS occurs when molecules are positioned on top of the metal surface of which the corrugation is provided by nanostructures of silver or gold, by surface plasmon resonance.

In general, the fluorescence and quenching of fluorophores, FRET, and LSPR and SERS of metal nanoparticles are sensitive to the distance between the nanoparticles or the distance from the surface of metal/dielectric adjacent to the nanoparticles.

However, the length of a layer determining the distance between the nanoparticles is generally fixed. Therefore, the energy transfer condition between the nanoparticles cannot be controlled actively.

Therefore, there is a demand for an optical sensor which is capable of actively controlling the energy transfer condition between the nanoparticles. In particular, there is a demand for an optical sensor using a nano-spacer a length of which may be varied by external stimuli such as temperature, pH, light intensity, or wavelength, in order to overcome the disadvantage of a typical spacer having a fixed length.

### SUMMARY OF THE INVENTION

An aspect of the present invention provides an optical sensor using a nano-spacer which is capable of controlling and detecting optical properties through external stimuli.

Another aspect of the present invention provides a detection method using an optical sensor which is capable of controlling and detecting optical properties through external stimuli.

According to an aspect of the present invention, there is provided an optical sensor including: a nano-spacer a length of which is reversibly varied depending on an external stimuli; a first material body coupled to one side of the nano-spacer; a second material body coupled to the other side of the nano-spacer; and a detection unit detecting light emitted by an interaction between the first material body and the second material body.

The external stimuli may include at least one of temperature, humidity, pH, intensity of light, and wavelength of light.

The external stimuli may have a critical condition in which the length of the nano-spacer is varied.

The distance between the first material body and the second material body may be varied depending on the variation in the length of the nano-spacer.

The nano-spacer may include at least one of a polymer and a hydrogel.

The nano-spacer may include poly(N-isopropylacrylamide) (PNIPAAm).

The interaction between the first material body and the second material body may be exhibited as anyone of fluorescence, fluorescence resonance energy transfer (FRET), localized surface plasmon resonance (LSPR), and surface enhanced Raman spectroscopy (SERS).

When the interaction between the first material body and the second material body is exhibited as any one of the fluorescence and the FRET, the first material body and the second material body may include fluorophores.

When the interaction between the first material body and the second material body is exhibited as anyone of the LSPR or the SERS, the first material body may include a fluorophores, and the second material body may include a metal nanoparticle.

The detection unit may detect the variation in the intensity and/or wavelength of light emitted by the interaction between the first material body and the second material body depending on the variation in the length of the nano-spacer.

According to another aspect of the present invention, there is provided a detection method using an optical sensor, including: coupling a first material body to one side of a nano-spacer a length of which is reversibly varied depending on an external stimuli, and coupling a second material body to the other side of the nano-spacer; applying the external stimuli to the nano-spacer to which the first material body and the second material body are coupled; and detecting light emitted by an interaction between the first material body and the second material body.

The nano-spacer may include any one of a polymer and a hydrogel.

The nano-spacer may include PNIPAAm.

The external stimuli may include at least one of temperature, humidity, pH, intensity of light, and wavelength of light.

The external stimuli may have a critical condition in which the length of the nano-spacer is varied.

In the applying of the external stimuli, the external stimuli may be periodically varied.

In the detecting of the emitted light, of the variation in the intensity and/or wavelength of the emitted light depending on the variation of the external stimuli may be detected.

In the detection of the emitted light, the interaction between the first material body and the second material body may be exhibited as any one of fluorescence, FRET, LSPR, and SERS.

When the interaction between the first material body and the second material body is exhibited as any one of the fluorescence and the FRET, the first material body and the second material body may include fluorophores.

When the interaction between the first material body and the second material body is exhibited as anyone of the LSPR and the SERS, the first material body may include a fluorophores, and the second material body may include a metal nanoparticle.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is an exemplary diagram explaining an optical sensor using a nano-spacer according to an embodiment of the present invention;

FIGS. 2A and 2B are exemplary diagrams explaining fluorescence resonance energy transfer (FRET) in the optical sensor using the nano-spacer according to the embodiment of the present invention;

FIGS. 3A and 3B are exemplary diagrams explaining localized surface plasmon resonance (LSPR) in the optical sensor using the nano-spacer according to the embodiment of the present invention; and

FIG. 4 is a flow chart explaining a detection method using an optical sensor according to an embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. Like reference numerals in the drawings denote like elements, and thus their description will be omitted.

However, the present invention is not limited to specific embodiments, and may include all modifications, equivalents, and substitutes included in the technical spirit and scope of the present invention.

It will be understood that although the terms “first” and “second” are used herein to describe various elements, these elements should not be limited by these terms. These terms are only used to distinguish one element from another element. For example, a first element may be designated as a second element, without departing from the spirit and scope of the invention as defined by the appended claims. Similarly, the second element may be designated as the first element. The term “and/or” may include a combination of plural relevant constituent elements or any one of plural relevant constituent elements.

When it is described that one component is “connected” or “coupled” to another component, the one component may be directly connected or coupled to another component. However, it will be understood that intervening component may exist therebetween. On the other hand, when it is described that one component is “directly connected” or “directly coupled” to another component, it will be understood that no components exist therebetween.

The terms used in this specification are used for describing specific embodiments and do not limit the scope of the present invention. A singular expression may include a plural expression, as long as they are obviously different from each other in context. In this application, the meaning of “include” or “have” specifies a property, a fixed number, a step, a process, an element, a component, and/or a combination thereof but does not exclude other properties, fixed numbers, steps, processes, elements, components, and/or combinations thereof.

The terms used herein, including technical and scientific terms, have the same meanings as terms that are generally understood by those skilled in the art, as long as the terms are differently defined. It should be understood that terms defined in a generally-used dictionary have meanings coinciding with those of terms in the related technology. As long as the terms are not defined obviously, they are not ideally or excessively analyzed as formal meanings.

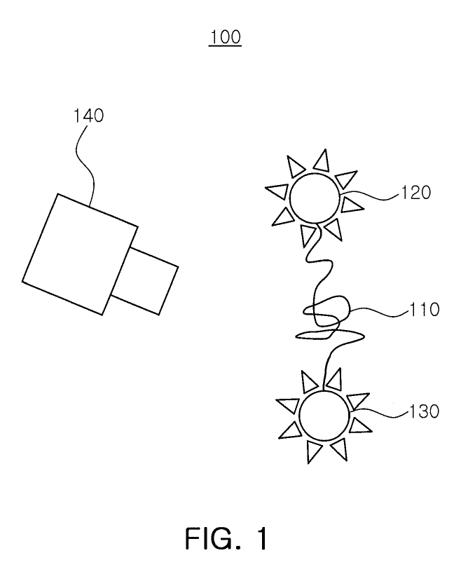

FIG. 1 is an exemplary diagram explaining an optical sensor using a nano-spacer according to an embodiment of the present invention.

Referring to FIG. 1, the optical sensor 100 using a nano-spacer according to the embodiment of the present invention may include a nano-spacer 110, a first material body 120, a second material body 130, and a detection unit 140. The length of the nano-spacer 110 is reversibly varied depending on external stimuli. The first material body 120 is coupled to one side of the nano-spacer 110. The second material body 130 is coupled to the other side of the nano-spacer 110. The detection unit 140 detects light emitted by an interaction between the first material body 120 and the second material body 130.

The external stimuli may be at least one of temperature, humidity, pH, intensity of light, and wavelength of light. Each of the temperature, the humidity, the pH, the intensity of light, and the wavelength of light may have a critical condition at which the length of the nano-spacer is varied.

The nano-spacer 110 may be formed of at least one of a polymer and a hydrogel. In particular, the nano-spacer 110 may be formed of poly(N-isopropylacrylamide) (PNIPAAm).

The first material body 120 and the second material body 130 may be fluorophores and metal nanoparticles. Accordingly, the interaction between the first material body 120 and the second material body 130 may be exhibited as any one of fluorescence, fluorescence resonance energy transfer (FRET), localized surface plasmon resonance (LSPR), and surface enhanced Raman spectroscopy (SERS).

Specifically, when the interaction between the first material body 120 and the second material body 130 is exhibited as any one of the fluorescence and the FRET, the first material body 120 and the second material body 130 may be fluorophores. When the interaction between the first material body 120 and the second material body 130 is exhibited as any one of the LSPR and the SERS, the first material body 120 may be a fluorophores and the second material body 130 may be a metal nanoparticle.

The detection unit 140 may detect variation in intensity and/or wavelength of light emitted by the interaction between the first material body 120 and the second material body 130, depending on variation in the length of the nano-spacer.

Consequently, the external stimuli are applied to the combination of the nano-spacer 110, the first material body 120, and the second material body 130. The external stimuli may vary the length of the nano-spacer 110.

The distance between the first material body 120 and the second material body 130 may be varied, depending on the variation in the length of the nano-spacer 110. Using the variation in the distance between the first material body 120 and the second material body 130, it is possible to detect the variation in the intensity of light caused by the fluorescence, the FRET, the LSPR, or the SERS.

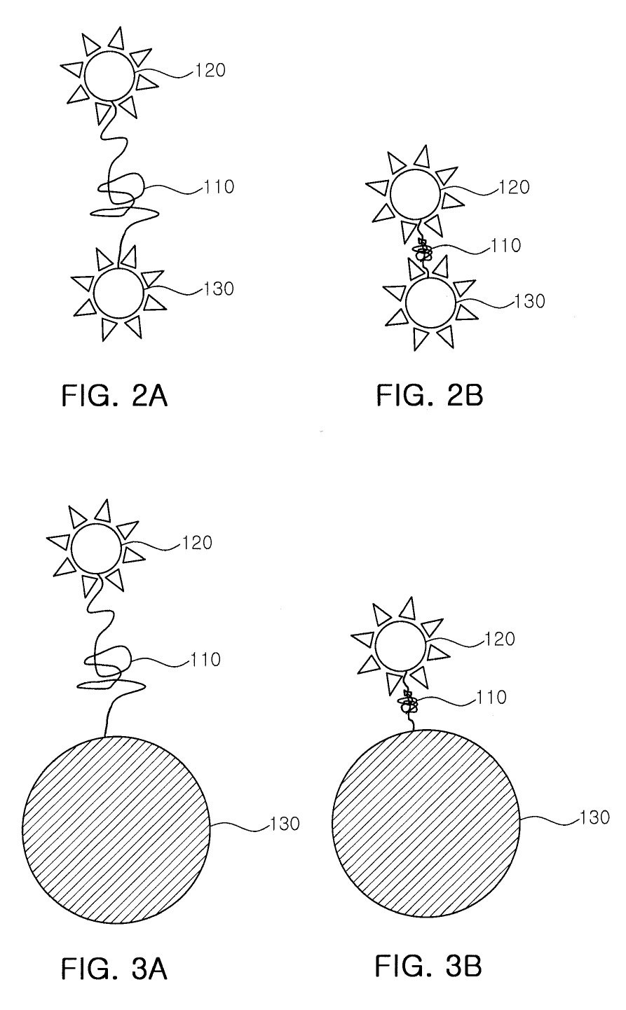

FIGS. 2A and 2B are exemplary diagrams explaining the FRET in the optical sensor using the nano-spacer according to the embodiment of the present invention.

In the optical sensor 100 using the nano-spacer according to the embodiment of the present invention, a case in which the interaction between the first material body 120 and the second material body 130 is exhibited as the FRET will be described below with reference to FIGS. 2A and 2B. In this case, the first material body 120 may be a fluorophores and the second material body 130 may also be a fluorophores.

As illustrated in FIG. 2A, before the external stimuli is applied, the distance between the first material body 120 and the second material body 130 by the nano-spacer 110 may be maintained to be long. Accordingly, since the energy corresponds to the fluorescence energy of the first material body 120 is not transferred to the second material body 130, the scattering or the fluorescence of the first material body 120 is not reduced.

However, as illustrated in FIG. 2B, after the external stimuli is applied, the distance between the first material body 120 and the second material body 130 by the nano-spacer becomes shorter. Accordingly, the interaction between the first material body 120 and the second material body 130 causes a quenching phenomenon in which the energy corresponds to the fluorescence energy of the first material body 120 is transferred from the first material body 120 to the second material body 130. That is, it can be detected that the intensity of light emitted by the second material body 130 is quenched.

Using the variation of the external stimuli, the variation in the intensity and/or wavelength of light emitted by the FRET can be detected. Consequently, the characteristic of the interaction between the first material body 120 and the second material body 130 can be detected.

FIGS. 3A and 3B are exemplary diagrams explaining the LSPR in the optical sensor using the nano-spacer according to the embodiment of the present invention.

In the optical sensor using the nano-spacer according to the embodiment of the present invention, a case in which the interaction between the first material body 120 and the second material body 130 is exhibited as the LSPR will be described below with reference to FIGS. 3A and 3B. In this case, the first material body 120 may be a fluorophores, and the second material body 130 may also be a metal nanoparticle.

As illustrated in FIG. 3A, before the external stimuli is applied, the distance between the first material body 120 and the second material body 130 by the nano-spacer 110 may be maintained to be large. Accordingly, non-radioactive energy is not transferred from the first material body 120 to the second material body 130. Therefore, it can be detected that the scattering or intensity of fluorescent light of the first material body 120 is not reduced.

However, as illustrated in FIG. 3B, after the external stimuli is applied, the distance between the first material body 120 and the second material body 130 by the nano-spacer is reduced. Accordingly, the interaction between the first material body 120 and the second material body 130 causes a non-radioactive energy transfer from the first material body 120 to the second material body 130. When the energy (i.e., wavelength) of the first material body corresponds to the LSPR energy (i.e., resonance wavelength) of the second material body, that is, the metal nanoparticle, it can be detected that the intensity of light emitted from the second material body 130 is strong.

Using the variation of the external stimuli, the variation in the intensity and/or the wavelength of light emitted by the LSPR can be detected. Consequently, the characteristic of the interaction between the first material body 120 and the second material body 130 can be detected.

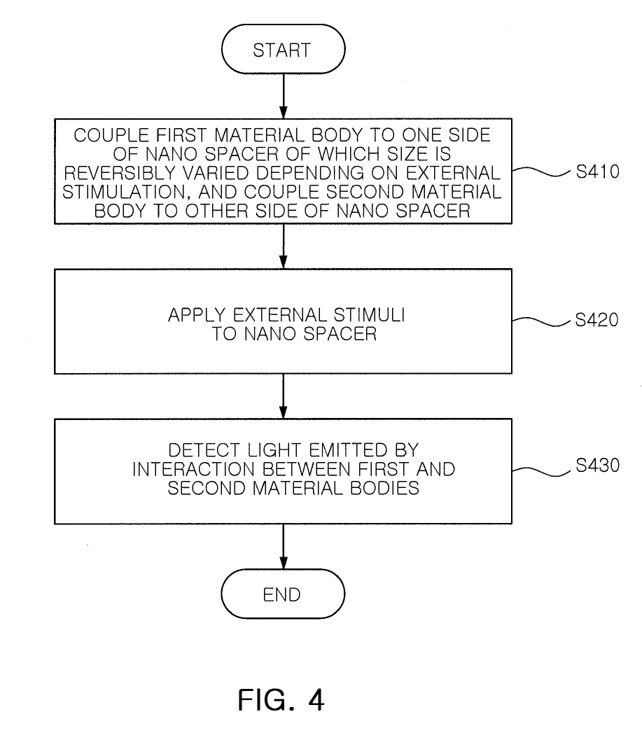

FIG. 4 is a flow chart explaining a detection method using an optical sensor according to an embodiment of the present invention.

Referring to FIG. 4, the detection method using the optical sensor according to the embodiment of the present invention may include: coupling a first material body to one side of a nano-spacer a length of which reversibly varies depending on an external stimuli and coupling a second material body to the other side of the nano-spacer (S410); applying the external stimuli to the nano-spacer to which the first and second material bodies are coupled (S420); and detecting light emitted by an interaction between the first material body and the second material body (S430).

The nano-spacer may be formed of any one of a polymer and a hydrogel. The nano-spacer may be formed of PNIPAAm.

Since operation S410 of coupling the first material body to one side of the nano-spacer a length of which reversibly varies depending on the external stimuli and coupling the second material body to the other side of the nana spacer has been described above in the optical sensor using the nano-spacer, detailed description thereof will be omitted.

In operation S420 of applying the external stimuli to the nano-spacer, the external stimuli including at least one of temperature, humidity, pH, intensity of light, and wavelength of light may be applied to the combination of the nano-spacer, the first material body, and the second material body.

The external stimuli may have a critical condition at which the length of the nano-spacer is varied. In operation S420 of applying the external stimuli, the external stimuli may be varied periodically. Accordingly, the features depending on the variation of the external stimuli can be detected.

In operation S430 of detecting light emitted by the interaction between the first material body and the second material body, the variation in the intensity and/or wavelength of the light emitted by the interaction between the first material body and the second material body can be detected.

In the operation S430, the interaction between the first material body and the second material body may be exhibited as any one of fluorescence, FRET, LSPR, and SERS.

Accordingly, in a case in which the interaction between the first material body and the second material body is exhibited as any one of the fluorescence or the FRET, fluorophores may be used as the first material body and the second material body. In a case in which the interaction between the first material body and the second material body is exhibited as any one of the LSPR and the SERS, a fluorophores may be used as the first material body, and a metal nanoparticle may be used as the second material body.

According to the embodiments of the present invention, the use of the nano-spacer a length of which reversibly varies depending on the external stimuli makes it possible to actively control the optical properties between nanoparticles, such as the fluorescence, the FRET, the LSPR, and the SERS.

Furthermore, the use of the nano-spacer makes it possible to improve the sensing limit of optical sensors based on the fluorescence, the FRET, the LSPR, and the SERS.

While the present invention has been shown and described in connection with the exemplary embodiments, it will be apparent to those skilled in the art that modifications and variations can be made without departing from the spirit and scope of the invention as defined by the appended claims.

What is claimed is:

1. An optical sensor comprising:
a nano-spacer a length of which is reversibly varied depending on external stimuli;
a first material body coupled to one side of the nano-spacer;
a second material body coupled to the other side of the nano-spacer; and
a detection unit detecting light emitted by an interaction between the first material body and the second material body.

2. The optical sensor of claim 1, wherein the external stimuli comprises at least one of temperature, humidity, pH, intensity of light, and wavelength of light.

3. The optical sensor of claim 2, wherein the external stimuli has a critical condition at which the length of the nano-spacer is varied.

4. The optical sensor of claim 1, wherein a distance between the first material body and the second material body is varied depending on the variation in the length of the nano-spacer.

5. The optical sensor of claim 1, wherein the nano-spacer comprises at least one of a polymer and a hydrogel.

6. The optical sensor of claim 5, wherein the nano-spacer comprises poly(N-isopropylacrylamide) (PNIPAAm).

7. The optical sensor of claim 1, wherein the interaction between the first material body and the second material body is exhibited as any one of fluorescence, fluorescence resonance energy transfer (FRET), localized surface plasmon resonance (LSPR), and surface enhanced Raman spectroscopy (SERS).

8. The optical sensor of claim 7, wherein when the interaction between the first material body and the second material body is exhibited as any one of the fluorescence and the FRET, the first material body and the second material body comprise fluorophores.

9. The optical sensor of claim 7, wherein when the interaction between the first material body and the second material body is exhibited as any one of the LSPR and the SERS, the first material body comprises a fluorophores, and the second material body comprises a metal nanoparticle.

10. The optical sensor of claim 1, wherein the detection unit detects of the variation in the intensity and/or wavelength of light emitted by the interaction between the first material body and the second material body depending on the variation in the length of the nano-spacer.

11. A detection method using an optical sensor, comprising:
coupling a first material body to one side of a nano-spacer a length of which is reversibly varied depending on external stimuli, and coupling a second material body to the other side of the nano-spacer;
applying the external stimuli to the nano-spacer to which the first material body and the second material body are coupled; and
detecting light emitted by an interaction between the first material body and the second material body.

12. The detection method of claim 11, wherein the nano-spacer comprises any one of a polymer and a hydrogel.

13. The detection method of claim 11, wherein the nano-spacer comprises poly(N-isopropylacrylamide) (PNIPAAm).

14. The detection method of claim 11, wherein the external stimuli comprises at least one of temperature, humidity, pH, intensity of light, and wavelength of light.

15. The detection method of claim 14, wherein the external stimuli has a critical condition at which the length of the nano-spacer is varied.

16. The detection method of claim 11, wherein, in the applying of the external stimuli, the external stimuli is periodically varied.

17. The detection method of claim 11, wherein, in the detecting of the emitted light, the variation in the intensity and/or wavelength of the emitted light depending on the variation of the external stimuli is detected.

18. The detection method of claim 11, wherein, in the detection of the emitted light, the interaction between the first material body and the second material body is exhibited as any one of fluorescence, fluorescence resonance energy transfer (FRET), localized surface plasmon resonance (LSPR), and surface enhanced Raman spectroscopy (SERS).

19. The detection method of claim 18, wherein when the interaction between the first material body and the second material body is exhibited as any one of the fluorescence and the FRET, the first material body and the second material body comprise fluorophores.

20. The detection method of claim 18, wherein when the interaction between the first material body and the second material body is exhibited as any one of the LSPR and the SERS, the first material body comprises a fluorophores, and the second material body comprises a metal nanoparticle.
